(19) United States
(12) Patent Application Publication
(10) Pub. No.: US 2019/0066462 A1
(43) Pub. Date: Feb. 28, 2019

(54) MONSTER DETECTION ASSEMBLY

(71) Applicant: Michael Sipes, Murrayville, IL (US)

(72) Inventor: Michael Sipes, Murrayville, IL (US)

(21) Appl. No.: 15/690,345

(22) Filed: Aug. 30, 2017

(51) Int. Cl. G08B 7/06; G08C 17/02

(52) U.S. Cl. CPC G08B 7/06; G08C 17/02

(57) ABSTRACT

A monster detection assembly includes a detection unit that may be coupled to a support surface, such as a wall or a ceiling in a child's bedroom. The detection unit selectively emits light outwardly therefrom to simulate a detection sequence for monsters and other fictional characters in the child's bedroom. A remote unit is provided and the remote unit is manipulated by a child when the child is in bed. The remote unit is in wireless communication with the detection unit. The detection unit generates the detection sequence when the remote unit is manipulated. Additionally, the remote unit selectively emits audible sounds when the detection unit generates the detection sequence. In this way the remote unit confirms to the child that no monsters were detected thereby soothing the child.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

### (2) Description of Related Art Including Information Disclosed Under 37 CFR 1.97 and 1.98

The disclosure and prior art relates to detection devices and more particularly pertains to a new detection device for simulating monster detection in a child's bedroom.

### (h) BRIEF SUMMARY OF THE INVENTION

An embodiment of the disclosure meets the needs presented above by generally comprising a detection unit that may be coupled to a support surface, such as a wall or a ceiling in a child's bedroom. The detection unit selectively emits light outwardly therefrom to simulate a detection sequence for monsters and other fictional characters in the child's bedroom. A remote unit is provided and the remote unit is manipulated by a child when the child is in bed. The remote unit is in wireless communication with the detection unit. The detection unit generates the detection sequence when the remote unit is manipulated. Additionally, the remote unit selectively emits audible sounds when the detection unit generates the detection sequence. In this way the remote unit confirms to the child that no monsters were detected thereby soothing the child.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a monster detection assembly according to an embodiment of the disclosure.

FIG. 2 is a bottom phantom view of a remote unit of an embodiment of the disclosure.

FIG. 3 is a top view of an embodiment of the disclosure.

FIG. 4 is a front phantom view of detection unit of an embodiment of the disclosure.

FIG. 5 is a bottom phantom view of a detection unit of an embodiment of the disclosure.

FIG. 6 is a schematic view of an embodiment of the disclosure.

FIG. 7 is perspective in-use view of an embodiment of the disclosure.

### (j) DETAILED DESCRIPTION OF THE INVENTION

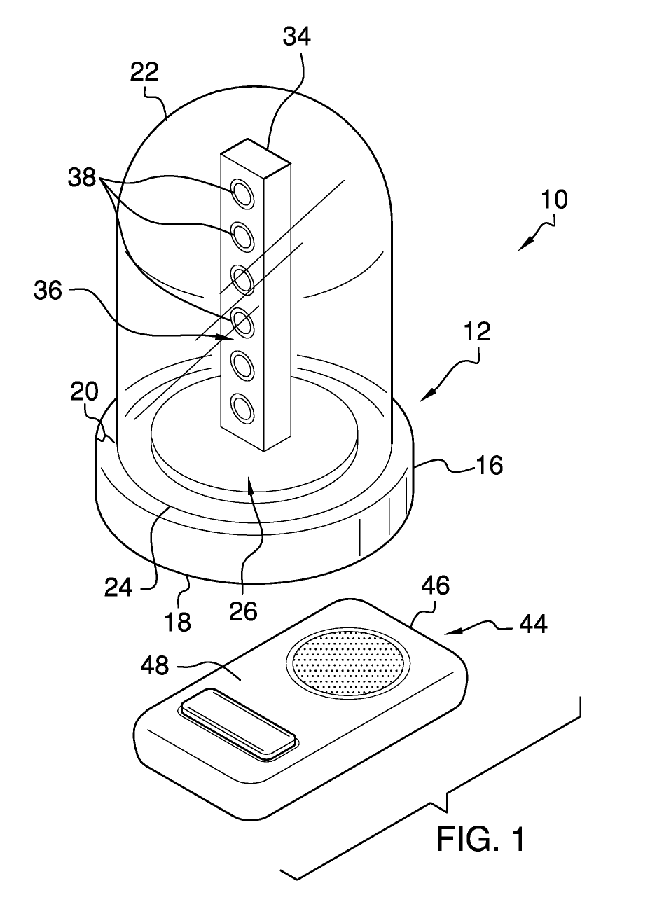

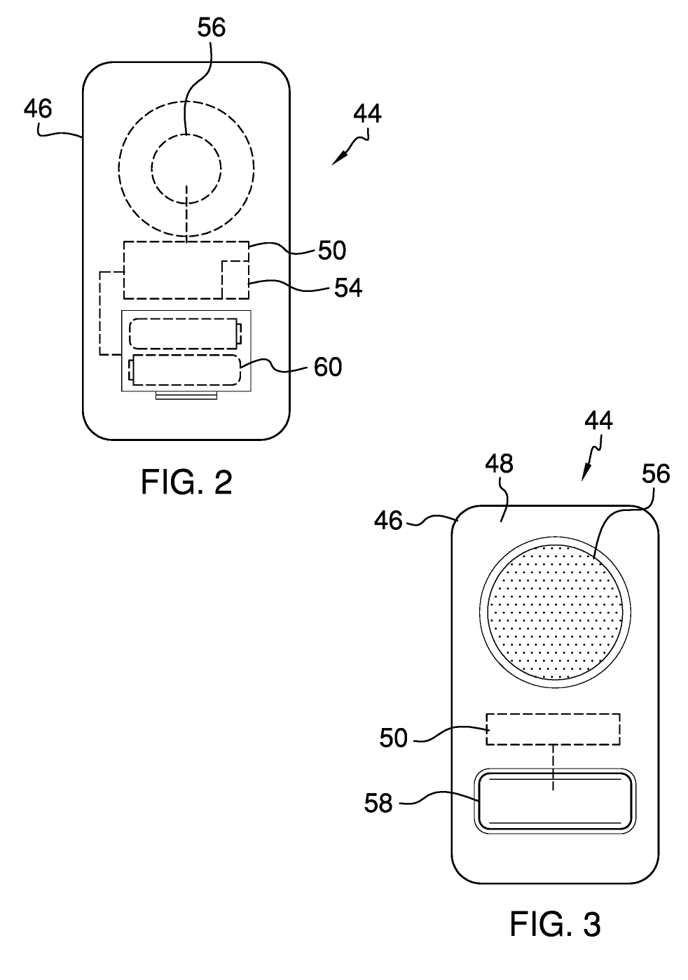

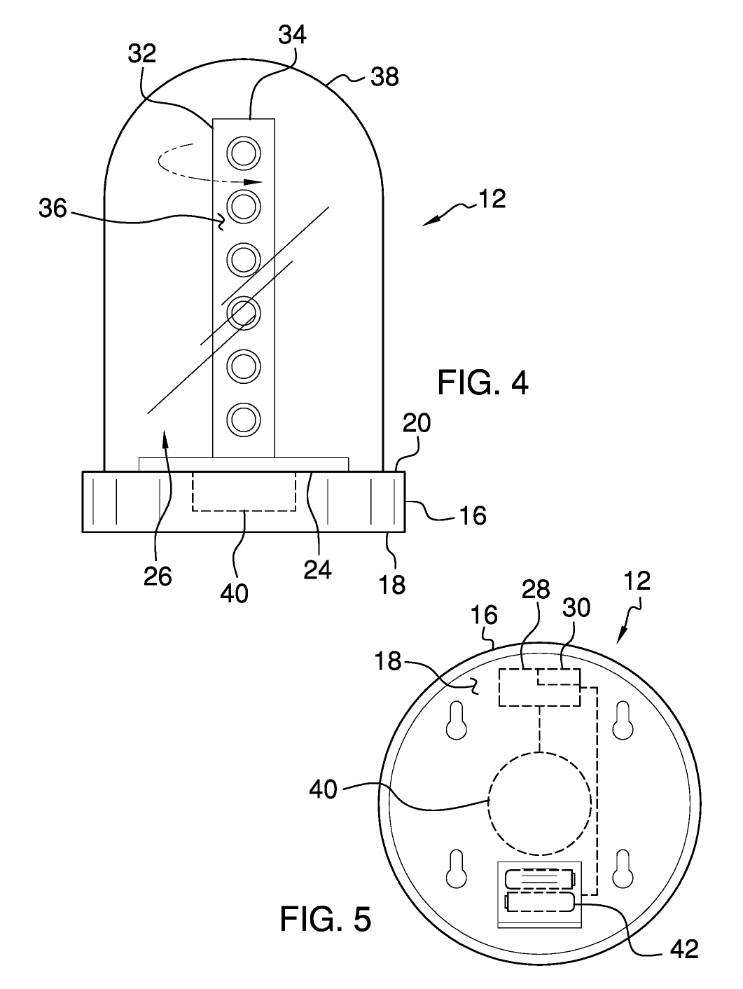

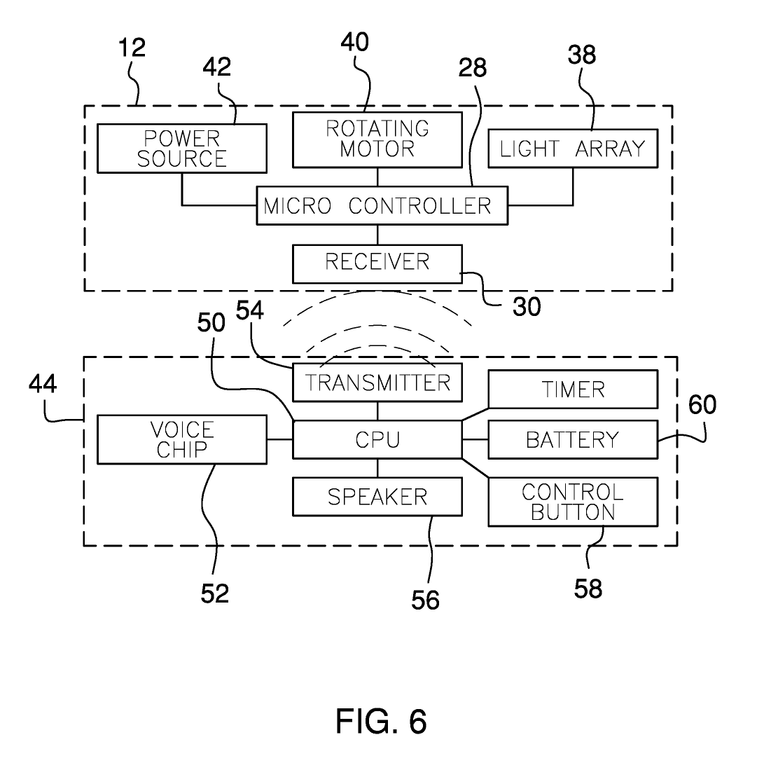

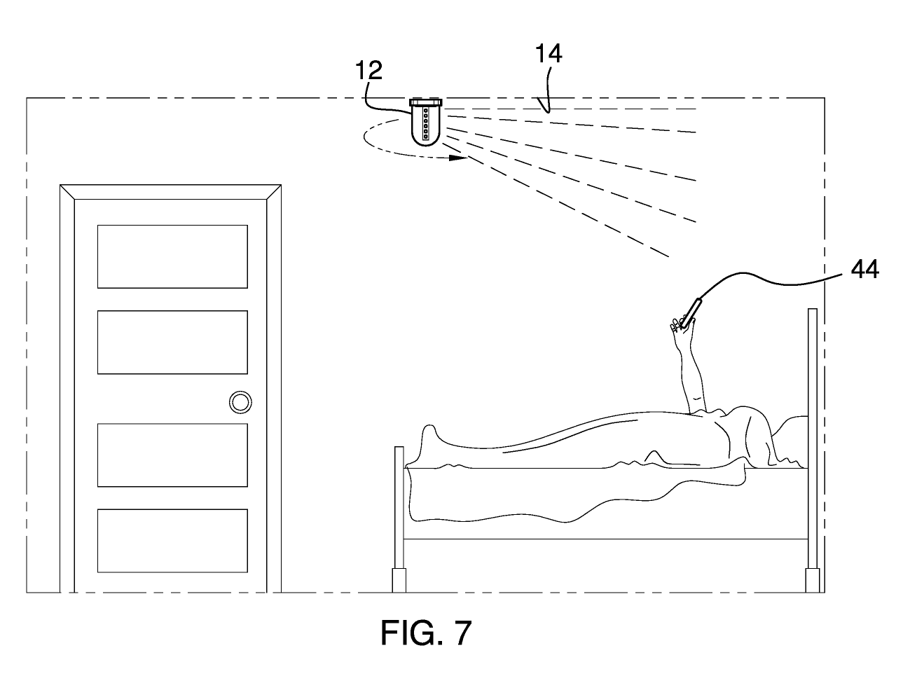

With reference now to the drawings, and in particular to FIGS. 1 through 7 thereof, a new detection device embodying the principles and concepts of an embodiment of the disclosure and generally designated by the reference numeral 10 will be described.

As best illustrated in FIGS. 1 through 7, the monster detection assembly 10 generally comprises a detection unit 12 that is coupled to a support surface 14. The detection unit 12 is positioned in a child's bedroom. Additionally, the support surface 14 may be a ceiling or a wall in the child's bedroom. The detection unit 12 selectively emits light outwardly therefrom. In this way the detection unit 12 simulates a detection sequence for monsters and other fictional characters in the child's bedroom.

The detection unit 12 comprises a base 16 that has a first surface 18 and a second surface 20. The first surface 18 is attached to the support surface 14 and the base 16 may be shaped like a disk. A jar 22 is provided that has a first edge 24 defining an opening 26 into the jar 22. The first edge 24 is coupled to the second surface 20 of the base 16 and the jar 22 is centrally positioned on the base 16. The jar 22 is comprised of a translucent material such as glass or the like.

A first processor 28 is provided and the first processor 28 is positioned within the base 16. The first processor 28 selectively generates a detection sequence. A receiver 30 is positioned within the base 16 and the receiver 30 is electrically coupled to the first processor 28. The receiver 30 may be a radio frequency receiver or the like and the first processor 28 may be an electronic processor or the like.

A member 32 is rotatably coupled to the second surface 20 of the base 16. The member 32 has a distal end 34 with respect to the base 16 and an outer surface 36.

Moreover, the member 32 is selectively rotated about an axis extending through the distal end 34 and the second surface 20. A plurality of light emitters 38 is provided and each of the light emitters 38 is coupled to the outer surface 36 of the member 32. Each of the light emitters 38 is electrically coupled to the first processor 28. Moreover, each of the light emitters 38 is turned on when the first processor 28 generates the detection sequence. The plurality of light emitters 38 emits a beam of light across the child's room when the first processor 28 generates the detection sequence. Each of the light emitters 38 may comprise an LED or the like.

A motor 40 is provided and the motor 40 positioned within the base 16. The member 32 is rotatably coupled to the motor 40 such that the motor 40 rotates the member 32 about the axis. The motor 40 is turned on when the first processor 28 generates the detection sequence. In this way the motor 40 urges the beam of light around the child's room. Thus, the motor 40 and the plurality of light emitters 38 simulate the detection sequence for monsters. The motor 40 may be an electric motor 40 or the like. A first power supply 42 is positioned in the base 16 and the first power supply 42 is electrically coupled to the first processor 28. The first power supply 42 comprises at least one battery. A first battery cover is removably coupled to the first surface 18 of the base 16 and the first power supply 42 is positioned beneath the first battery cover.

A remote unit 44 is provided and the remote unit 44 is manipulated by a child when the child is in bed. The remote unit 44 is in wireless communication with the detection unit 12. Moreover, the detection unit 12 generates the detection sequence when the remote unit 44 is manipulated. The remote unit 44 selectively emits audible sounds when the detection unit 12 generates the detection sequence. In this way the remote unit 44 confirms to the child that no monsters where detected thereby soothing the child.

The remote unit 44 comprises a remote control 46 that may be manipulated. The remote control 46 has an outer wall 48 and a second processor 50 is positioned within the remote control 46. The second processor 50 selectively generates an activation sequence.

An electronic memory 52 is positioned within the remote control 46 and the electronic memory 52 is electrically coupled to the second processor 50. The electronic memory 52 stores data pertaining to a first verbal statement and a second verbal statement. Additionally, the electronic memory 52 may store a catalogue of fictional characters commonly associated with childhood fears, such as the boogey man or the like. The electronic memory 52 may be ROM memory or the like.

A transmitter 54 is positioned within the remote control 46 and the transmitter 54 is electrically coupled to the second processor 50. The transmitter 54 is in electrical communication with the receiver 30. Moreover, the first processor 28 generates the detection sequence when the second processor 50 generates the activation sequence. The transmitter 54 may be a radio frequency transmitter 54 or the like.

A speaker 56 is coupled to the outer wall 48 of the remote control 46 and the speaker 56 emits audible sounds outwardly therefrom. The speaker 56 is electrically coupled to the second processor 50. Additionally, the speaker 56 emits the verbal statement stored in the electronic memory 52. The speaker 56 is turned on when the second processor 50 generates the activation sequence. The first verbal statement may comprise the words “Scanning in progress” and the second verbal statement may comprise the words “Scanning complete. No monster found.”. The second processor 50 may include an electronic timer.

A button 58 is movably coupled to the outer wall 48 of the remote control 46 and the button 58 is selectively depressed. The button 58 is electrically coupled to the second processor 50 and the second processor 50 generates the activation sequence when the button 58 is manipulated. A second power supply 60 is positioned within the remote control 46 and the second power supply 60 is electrically coupled to the second processor 50. The second power supply 60 comprises at least one battery. A second battery cover is removably coupled to the outer wall 48 of the remote control 46 and the second power supply 60 is positioned beneath the second battery cover.

In use, the base 16 is mounted in a selected location in the child's room. The remote control 46 is given to the child when the child goes to bed at night. The child selectively depresses the button 58 to activate the detection unit 12. The speaker 56 emits the first verbal statement and the motor 40 is turned on. The light emitters 38 are turned on and the motor 40 rotates the beam of light around the room to simulate scanning for monsters. The speaker 56 emits the second verbal statement approximately fifteen seconds after the first verbal statement. In this way the child is reassured that no monsters or other fictional characters are present in the child's room when the child is going to bed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded.

A reference to an element by the indefinite article “a” does not exclude the possibility that more than one of the element is present, unless the context clearly requires that there be only one of the elements.

1. A monster detection assembly being configured to comfort a child when the child is sleeping, said assembly comprising:
a detection unit being configured to be coupled to a support surface, said detection unit being configured to be positioned in a child's bedroom, said detection unit selectively emitting light outwardly therefrom wherein said detection unit is configured to simulate a detection sequence for monsters and other fictional characters in the child's bedroom, said detection unit including
a base having a first surface and a second surface, said first surface being configured to be attached to the support surface,
a first processor being positioned within said base, said first processor selectively generating said detection sequence,
a receiver being positioned within said base, said receiver being electrically coupled to said first processor,
a member being rotatably coupled to said second surface of said base, said member having a distal end with respect to said base and an outer surface, said member being selectively rotated about an axis extending through said distal end and said second surface,
a plurality of light emitters, each of said light emitters being coupled to said outer surface of said member, each of said light emitters being electrically coupled to said processor, each of said light emitters being turned on when said processor generates said detection sequence wherein said plurality of light emitters is configured to emit a beam of light across the child's room; and
a remote unit being configured to be manipulated by a child when the child is in bed, said remote unit being in wireless communication with said detection unit, said detection unit generating said detection sequence when said remote unit is manipulated, said remote unit selectively emitting audible sounds when said detection unit generates said detection sequence wherein said remote unit is configured to confirm to the child that no monsters were detected thereby soothing the child.

2. The assembly according to claim 1, said detection unit further comprising a jar having a first edge defining an opening into said jar, said first edge being coupled to said second surface of said base, said jar being comprised of a translucent material, said jar extending over and around said member.

3. (canceled)

4. (canceled)

5. (canceled)

6. The assembly according to claim 1, further comprising a motor being positioned within said base, said member being rotatably coupled to said motor such that said motor rotates said member about said axis, said motor being turned on when said processor generates said detection sequence wherein said motor is configured to urge the beam of light around the child's room.

7. The assembly according to claim 6, further comprising a first power supply being positioned in said base, said first power supply being electrically coupled to said first processor, said first power supply comprising at least one battery.

8. The assembly according to claim 1, wherein said remote unit comprises:
a remote control being configured to be manipulated, said remote control having an outer wall; and
a second processor being positioned within said remote control, said second processor selectively generating an activation sequence.

9. The assembly according to claim 8, further comprising an electronic memory being positioned within said remote control, said electronic memory being electrically coupled to said second processor, said electronic memory storing data pertaining to a verbal statement.

10. The assembly according to claim 9, further comprising a transmitter being positioned within said remote control, said transmitter being electrically coupled to said second processor, said transmitter being in electrical communication with said receiver, said first processor generating said detection sequence when said second processor generates said activation sequence.

11. The assembly according to claim 9, further comprising a speaker being coupled to said outer wall of said remote control wherein said speaker is configured to emit audible sounds outwardly therefrom, said speaker being electrically coupled to said second processor wherein said speaker is configured to emit the verbal statement stored in said electronic memory, said speaker being turned on when said second processor generates said activation sequence.

12. The assembly according to claim 8, further comprising a button being movably coupled to said outer wall of said remote control wherein said button is configured to be manipulated, said button being electrically coupled to said second processor, said second processor generating said activation sequence when said button is manipulated.

13. The assembly according to claim 8, further comprising a second power supply being positioned within said remote control, said second power supply being electrically coupled to said second processor, said second power supply comprising at least one battery.

14. A monster detection assembly being configured to comfort a child when the child is sleeping, said assembly comprising:
a detection unit being configured to be coupled to a support surface, said detection unit being configured to be positioned in a child's bedroom, said detection unit selectively emitting light outwardly therefrom wherein said detection unit is configured to simulate a detection sequence for monsters and other fictional characters in the child's bedroom, said detection unit comprising:
a base having a first surface and a second surface, said first surface being configured to be attached to the support surface,
a jar having a first edge defining an opening into said jar, said first edge being coupled to said second surface of said base, said jar being comprised of a translucent material,
a first processor being positioned within said base, said first processor selectively generating a detection sequence,
a receiver being positioned within said base, said receiver being electrically coupled to said first processor,
a member being rotatably coupled to said second surface of said base, said member having a distal end with respect to said base and an outer surface, said member being selectively rotated about an axis extending through said distal end and said second surface,
a plurality of light emitters, each of said light emitters being coupled to said outer surface of said member, each of said light emitters being electrically coupled to said first processor, each of said light emitters being turned on when said first processor generates said detection sequence wherein said plurality of light emitters is configured to emit a beam of light across the child's room,
a motor being positioned within said base, said member being rotatably coupled to said motor such that said motor rotates said member about said axis, said motor being turned on when said first processor generates said detection sequence wherein said motor is configured to urge the beam of light around the child's room, and
a first power supply being positioned in said base, said first power supply being electrically coupled to said first processor, said first power supply comprising at least one battery; and
a remote unit being configured to be manipulated by a child when the child is in bed, said remote unit being in wireless communication with said detection unit, said detection unit generating said detection sequence when said remote unit is manipulated, said remote unit selectively emitting audible sounds when said detection unit generates said detection sequence wherein said remote unit is configured to confirm to the child that no monsters were detected thereby soothing the child, said remote unit comprising:
a remote control being configured to be manipulated, said remote control having an outer wall,
a second processor being positioned within said remote control, said second processor selectively generating an activation sequence,
an electronic memory being positioned within said remote control, said electronic memory being electrically coupled to said second processor, said electronic memory storing data pertaining to a verbal statement,
a transmitter being positioned within said remote control, said transmitter being electrically coupled to said second processor, said transmitter being in electrical communication with said receiver, said first processor generating said detection sequence when said second processor generates said activation sequence,
a speaker being coupled to said outer wall of said remote control wherein said speaker is configured to emit audible sounds outwardly therefrom, said speaker being electrically coupled to said second processor wherein said speaker is configured to emit the verbal statement stored in said electronic memory, said speaker being turned on when said second processor generates said activation sequence,
a button being movably coupled to said outer wall of said remote control wherein said button is configured to be manipulated, said button being electrically coupled to said second processor, said second processor generating said activation sequence when said button is manipulated, and
a second power supply being positioned within said remote control, said second power supply being electrically coupled to said second processor, said second power supply comprising at least one battery.
